(19) United States
(12) Patent Application Publication
(10) Pub. No.: US 2017/0103398 A1
(43) Pub. Date: Apr. 13, 2017

(54) PROCESS AND SYSTEM FOR PROVIDING AUTOMATED RESPONSES FOR TRANSACTION OPERATIONS

(71) Applicants: JASON NAPSKY, Boynton Beach, FL (US); GEORGE GREGORY STAMATIS, Pearl, MS (US); LLOYD BRIGGS, Milwaukee, OR (US)

(72) Inventors: JASON NAPSKY, Boynton Beach, FL (US); GEORGE GREGORY STAMATIS, Pearl, MS (US); LLOYD BRIGGS, Milwaukee, OR (US)

(21) Appl. No.: 15/267,574

(22) Filed: Sep. 16, 2016

Related U.S. Application Data
(63) Continuation of application No. 14/477,787, filed on Sep. 4, 2014.
(60) Provisional application No. 62/220,909, filed on Sep. 18, 2015.
(60) Provisional application No. 61/888,250, filed on Oct. 8, 2013.
(60) Provisional application No. 61/873,506, filed on Sep. 4, 2013.

(51) Int. Cl. G06Q 20/40; G06Q 20/32

(52) U.S. Cl. CPC G06Q 20/4016; G06Q 20/405; G06Q 20/407; G06Q 20/3226

(57) ABSTRACT

Various systems for managing chargeback, retrieval, and other requests from the card associations, issuing banks, merchant banks, or other financial institutions requiring a merchant's response are disclosed herein. Such systems may include various forms of hardware, software and manual processes intended to: (a) retrieve transaction requests; (b) retrieve merchant's transaction data; (c) gather merchant's data and compile with normalized transaction request data; (d) create response cases; (e) provide merchant notifications; and (f) transmit responses to requestors. With the present invention, these often independent and incompatible processes, including their non-standard data formats, are normalized and compiled into compatible formats that integrate and facilitate the automation of substantially all aspects of a given chargeback process in one embodiment.

This application claims priority from U.S. Provisional Patent Application No. 62/220,909, filed on Sep. 18, 2015, the contents of which are incorporated herein by reference. This application also claims priority from U.S. patent application Ser. No. 14/477,787, filed on Sep. 4, 2014, the contents of which are also incorporated herein by reference, which claims priority from U.S. Provisional Patent Application No. 61/888,250, filed on Oct. 8, 2013, the contents of which are also incorporated herein by reference, and which also claims priority from U.S. Provisional Patent Application No. 61/873,506, filed on Sep. 4, 2013, the contents of which are also incorporated herein by reference.

### FIELD OF THE INVENTION

This invention relates to processes and systems for an automated response to chargeback, retrieval, and other transaction requests related to the purchase of goods and/or services. Specifically, this invention relates to processes and systems that allow merchants and financial institutions to more efficiently manage chargeback and retrieval requests that can arise from financial transactions through the integration and normalization of previously independent and often incompatible data and retrieval systems used by merchants.

### BACKGROUND OF THE INVENTION

Consumers often engage in payment transactions with merchants for the purchase of goods or services. Ideally, such transactions result in a benefit to both parties: consumers receive the transacted-for goods or services, and merchants receive money or some other benefit in exchange. However, in some instances consumers may be unhappy with the goods or services received. Unfortunately, in other instances, consumers attempt to receive “something” for “nothing”, or perpetrate a fraud upon the merchant or bank issuing the payment card. Naturally, many chargeback requests are valid and result in consumers receiving a credit on their billing statement.

In many situations, consumers may have two potential courses of action to take when they are unsatisfied with a purchase. The first is that a consumer may return the product to the merchant and request reimbursement for the purchase. In such a situation, the merchant may examine the returned merchandise and, if satisfied, return the purchase amount to the consumer. However, some merchants may only refund the amount to a gift card used only at the merchant, provide in-store credit to the consumer, or place a hold on providing the refund to a payment card used to make the purchase. Such methods may leave the consumer unfulfilled, by either not timely receiving their money when they return the product, or by being forced to continue to still spend their money at the merchant, especially if the return was for reasons related to the merchant's service.

The second course of action is that the consumer may contact their issuer and initiate a chargeback. In a chargeback, the issuer of the payment account used to fund the transaction reverses the transaction and credits their account, and then submits a chargeback request to the merchant to receive the money for the transaction. Chargebacks may be advantageous over returns for consumers as the consumers may receive their money immediately, and may also not be restricted to a gift card or in-store credit that can only be used at the merchant. However, chargebacks often require significant steps to be performed by the consumer to be initiated. Many issuers require the consumer to submit a formal request for a chargeback, including providing detail as to the transaction and the nature of the request for a chargeback, such as by describing the deficiencies of a product that has left the consumer unsatisfied. In addition, chargebacks often place the burden of proof on the merchant in disputing a chargeback. As a result, consumers may request a chargeback and cite a defective product, even when the product is not defective, and the merchant may be unable to provide sufficient evidence of the non-defective product. This could result in a loss of both merchandise and money for the merchant.

Thus, there is a need to provide a technical system that can more easily initiate chargebacks with merchants while also protecting the merchants involved by processing chargebacks only in instances where products are to be returned.

More and more, merchants are facing increasing demands with respect to charge backs, both in terms of requests and retrievals. Conventional and current processes to handle chargeback and retrieval requests often require agents to manually investigate and compile certain aspects of requests and their corresponding transaction data. This can lead to inconsistent processing, delays in response causing loss of chargeback rights after a chargeback time limit has expired, and re-presentment requests and/or arbitration due to incorrect chargeback responses. Each credit card association and payments schema makes chargeback and retrieval requests to a merchant. However, they all do it quite differently with their own data formats and have developed their own unique data processes and guidelines. Ensuring compliance across all associations is a tough task even for large enterprise merchants. Additionally, credit card associations financially incentivize the banks to complete the retrieval request properly and within a relatively short timeframe. Most merchants do not have the resources or bandwidth to answer the requests; hence there is lost revenue when merchants do not respond in time. These and other drawbacks exist.

Facilitating the purchase of goods and services utilizing electronic means, such as but not limited to, enterprise shopping cart platforms, gateways, and processing entity technology, is a method used by many businesses worldwide. Such purchasing processes may be accomplished when the merchant presents their catalog of goods and services to the consumer, who in turn, chooses the desired product and proceeds to and completes the checkout process presented by the merchant's shopping cart or check-out process platform, thereby consummating and completing the shopping experience. While the consumer may have selected the product or service from a catalog, and subsequently completed the purchasing cycle, it may not necessarily have been the most suitable good or service for that particular individual. Under current systems and processes, the merchant has no means, method, or opportunity to efficiently and effectively review the proposed transaction and present the purchaser with better and potentially more suitable alternatives, prior to the completion of the checkout process.

Accordingly, it is desirable to provide a system whereby the merchant is provided with the opportunity to present and provide the consumer with an option to select and purchase a more suitable good or service, based upon analytical data gathered during and prior to completion of the checkout process.

### SUMMARY OF THE INVENTION

According to the present invention, a consumer or issuing bank may initiate a chargeback request, which is typical in the industry. The first step in any such request is to notify the credit card company. In turn, the credit card company notifies the card association or payment schema so that the merchant is subsequently charged (or not) based on the payment processing rules. As described in the background herein, various automated processes exist that assist with various parts of this system. The present invention automates normalization of data formats and provides responses by which the card association or payment schema determines whether the merchant gets to keep the money without additional fees or whether they lose money as a result of a chargeback. The electronic negotiation (that is, the exchange of data) between the card association or payment schema and the merchant is handled in an automated manner according to the present invention. In order to make that possible, the data exchanged must be normalized and then processed according to the individual and specific rules established by the card association or payment schema, which are incumbent upon the merchant.

While the process and system according to the present invention for the normalization of said data would appear to be a straightforward process, it is not. Notably, said process and system require handling data from diverse entities each with its own set of protocol and format parameters, which makes standardization next to impossible. For example, American Express has its own language and rule set so to speak as compared with for example, Discover Card, VISA or MasterCard. In order for the present invention to serve its intended purpose, an automated response system is interposed between the card association or payment schema and the merchant. That is a primary purpose of the present invention.

A summary of one system according to the present invention follows:

For the purposes of discussion, we will incorporate the following acronyms:

1. CBMS—Chargeback Management System

2. API—Application Program Interface

3. FTP—File Transfer Protocol

4. SFTP—Secure File Transfer Protocol

5. UI—User Interface

6. MID—Merchant ID

7. AMEX—American Express

8. CSV—Comma Separated Values

9. CA—Card Association or Payment Schema

10. ARS—Automatic Response System for a CBMS

Several different terms are worth defining according to the present invention:

1. Normalization—Normalization is the process of converting data or information from an obscure or proprietary format to one that can be used by the CBMS.

2. Chargeback—Chargeback and or Retrieval Request. This term is used symbolically to represent any type of request made against a commercial transaction.

3. Payment Device—The actual item used to make payment with; e.g. credit card. The individual credit card used in the transaction.

4. Nuisance Chargeback—Each card brand or payment schema can have a set of rules and regulation around the chargeback process. A chargeback that breaks one or more of the rules and/or regulations is referred to as a nuisance chargeback.

5. Data Logic Translation—System designed and integrated so that the rules engines in effect by various card associations and payments schema may be adapted and correlated into a common data protocol to be operated upon by the present invention, CBMS systems have come about because of the need to create a system that can respond quickly to a chargeback with minimal to no user interaction.

The core design behind the system is the normalization of data received by either merchant or the credit card company. Once the data has been normalized a rules engine (or a data logic translation engine) is used to create the chargeback response based on the normalized data. The rules engine provides a means to specify a rule applied to the attributes of the chargeback, its corresponding merchant transaction, historical data, and other data directly or indirectly associated with the transaction. For example, a merchant may decide that some chargeback reason codes should be ignored when they are received and in such a case a rule may be applied resulting in no response for requests containing the same reason code. The result of the rules engine is to determine the next course of action(s) for the incoming request; that includes not taking any further action.

The rules engine can also be used to police the chargeback ecosystem to ensure all parties adhere to the rules and regulations. CBMS can identify and point out when an individual chargeback, its requestor, or other entity is not following the rules and regulations. CBMS has a nuisance chargeback rule in order to reject the chargeback and/or respond appropriately. CBMS historical chargeback data can be used to make CBMS a better system, facilitate change to the ecosystem itself, and provide input to other systems in the ecosystem.

The CBMS system may require information or data from other systems. A module is used to manage the processes and connectivity associated with obtaining the information and/or data from other systems. One such system is an analysis system used to provide scoring and data about a transaction, the payment device used in the transaction, the consumer, and other relevant elements.

A third party shipping system such as FedEx, UPS, et al. is another one of those systems. It is used to verify delivery and obtain other relevant data about a shipment associated with a transaction. The additional data obtained from other systems may be required to process a rule, or to be used within a response, or reporting, or future analysis.

The system then connects to the originating card bank, card association, payment schema, or appropriate third party processor and sends the response using the pre-defined connections.

The ideal system would start out having received a chargeback, and then connect to the merchant via a web service in order to retrieve all necessary information in order to properly respond to the chargeback. In cases where the merchant cannot provide all related transaction data, a dump of all data is required so that transactional data may be matched up against the chargeback data.

This system according to the present invention may be divided into modules with specific responsibilities of data retrieval, data normalization, data submission, response creation, and response follow-up.

The data retrieval can be classified as chargeback, purchase, transaction or associated and supporting information. All data types require a specific setup in order to acquire all the necessary data for processing the chargeback. The data can be retrieved in various ways. An API or web service that allows CBMS to connect to data provider and retrieve information on demand. FTP, SFTP, and other file transfer methodologies can be used by CBMS to connect to a remote system and retrieve data from a specific resource location. SFTP push is where the data provider will push all relevant data to the CBMS by copying certain files to a specific folder that will be scanned at a later time. All data received must adhere to a predefined specification. There will be a format for each data retrieval that is either established by the data provider or the CBMS.

Once the data has been retrieved it must be normalized. The normalization process will be handled by a specific set of actions for each data provider. The data will be extracted from each data source and added to the CBMS database. During the normalization process the data will be associated with the corresponding data from the other systems. For example, the chargeback will be imported, and then the transaction data will be associated with it.

Once the data has been normalized and associated with all corresponding data, it will be processed through a rules engine or data translation logic assembly or engine. The engine will process the chargeback based on the reason code, other attributes of the chargeback, the corresponding transaction, and other relevant date to then apply certain rules. Once the chargeback has been analyzed a response will then be generated.

The final step is sending the response to the credit card company that initiated the chargeback. Subsequent analysis will be made via the APIs provide or other communication methodologies to determine the status of each response. Additionally, CBMS can submit data to others system for analysis and future use. For example, chargeback requests can be submitted to a fraud and chargeback scoring system. The fraud and chargeback scoring system will use that data to provide a score back to CBMS during the analysis and processing of a chargeback request.

Importantly, the present invention can deal with any merchant and any credit card issuer taking into account all the various data formats by using normalized data.

It's important that systems and processes that utilize the present invention handle and facilitate chargeback retrieval data. The chargeback retrieval module is broken up into sub-modules. The sub-modules are programmed for specific types of retrieval from various sources.

For example, for AMEX an API provided by them is available to retrieve a chargeback. A module is created to pull chargeback data for each merchant from them. The module uses SFTP to pull certain files from an AMEX server. Once the files have been downloaded, they are analyzed and the chargeback information is stored in the database.

For other issuing banks, card association, payment schema, or appropriate third party processor, a module is created for each one in order to pull or receive the chargeback data from them and store it in the database. Possible formats that we could receive from an issuing bank are CSV file, REST API, XML, and others.

The job of each module will be to establish connectivity with the issuing bank, card association, payment schema, or appropriate third party processor in the predetermined fashion to facilitate the retrieval of the chargeback data, and then store the chargeback data in the database.

Each module can be used for multiple merchants so they will only need to be created once per issuing bank, card association, payment schema, or appropriate third party processor.

As set forth herein, the present invention may be accomplished with a data retrieval process, whereby said process is modularized in order to better accommodate the various data sources that the system will need to connect to for retrieving all pertinent information.

As with the chargeback request, the data retrieval is setup to use various methods for retrieving the data. They may be an API, web service, FTP, CSV or some other method agreed upon by all parties.

Once the data has been retrieved each module will be responsible for extracting the data and putting it in the system's database. This means for more generic modules we require a specific format in order to normalize all data correctly. For more specific modules the format will be predefined and agreed upon by all parties. To be clear, the normalization of data is central to the present invention.

In addition, the translation of data logic to standard compatible formats is also central to the present invention, by way of so-called rules engines.

The rules engine responsibility is broken into 2 main responsibilities: validation and response creation. Each of these responsibilities may be separated into modules for easy maintenance and addition of new modules.

A configuration area is provided within CBMS to allow for chargeback specific codes. When a code is configured for use as part of the rules engine there are 3 main areas that are configured.

First are the general settings:

1. Code: The actual chargeback code that will be received from the issuing bank.

Card Type: The type of credit card from which the chargeback originated from. Response: A selection of the predefined response cover letter that will be used for the response.

2. The next section is the validations. The administrator will select from a list of predefined validations to make sure that the chargeback can be responded to. For example, there is a validation for amount. If the purchase does not meet the minimum amount specified by the validation field, the chargeback will be marked as invalid and the administrator will be notified.

3. The final section is for supporting documentation, data sets, transaction properties and attributes that can be added to the response. The administrator will select from a list of predefined supporting documentation, data sets, transaction properties and attributes.

When the rules engine runs it will process any new chargeback requests. The system according to the present invention will first evaluate the chargeback code and if it finds a corresponding rule, it will use the configuration for that rule. Then the engine will run through the validations. If any validation fails, the chargeback will be flagged as invalid and will require additional interaction by an administrator. If all validation passes, the engine will begin to construct the response based on the selected supporting documents.

Once the rules engine has created the chargeback response it will be sent back to the issuing bank, card association, payment schema, or appropriate third party processor. The same modules that were used for retrieving the chargeback will be used for responding. It will also be used to verify if the response was accepted or not.

In order to better provide a system that can be easily used across many different rails we normalize all data. Once the data is normalized, all auxiliary functions can easily determine if all the data is present in order to respond to the chargeback. It also allows for a quick validation of the chargeback request in order to make sure that it meets all requirements.

By using a normalized data set we are able to focus efforts on retrieving and normalizing the data. There are thousands of banks, merchants, shipping facilities, etc. that need to be accessed in order to provide all proofs required for a good chargeback response. By focusing on retrieving and normalizing we are able to use a more streamlined approach to deploy a continued support of the system and a more effective environment.

By breaking the system into modules, and each module into smaller modules for validation, proof retrieval, responses, and notifications, it makes maintenance and updates easier for development. In addition to maintaining smaller portions of code, the modular approach also allows for ease of extending the functionality without changing the core.

The module approach also allows for the system to be used in reverse on the other side of the chargeback request ecosystem. When used on the other side of the ecosystem, the modules can be used to determine if a chargeback request should be initiated, process the request, review the response and determine the appropriate action to be taken after processing the response.

The module approach along with a communications layer allows CBMS to interact directly when many different services, systems, platforms, entities, associations, individuals, et al. For example, CBMS can interface with a merchant, acquiring bank, issuing bank, mobile application, CRM and ERP system, payment solutions, and merchant solutions.

Examples of some overall design terms are useful to those of skill in the art pertinent to the present invention:

1. Company—This is the base data structure for the system. A company can be a child of another company.

2. Location—A location is a specific merchant location that a MID is associated with. A location has to belong to a company. A company can have more than one location associated with it.

3. MID—One or more Merchant Identification (MID) may be assigned to a location. The MID will be used to assign a chargeback to a given location.

4. Chargeback—This table holds all information from the chargeback request. It will also be used to relate it to other data and tables.

5. Transaction—The transaction data contains information about the purchase associated with the chargeback. This information will either be gathered from the merchant and/or processing bank.

6. User—This is used for storing information about the administrators including username and password. This table is also used for storing the permissions of each admin in a bit mapped integer.

7. User Company—Table structure used to define which parent company or location any given user can access.

The present invention seeks to resolve a multitude of problems in the field of chargeback management. Notably, one is called “cyber shoplifting”.

Cyber shoplifting is a technique whereby consumers/fraudsters utilize the existing Card Brand and Issuing Bank rules and regulations to initiate a chargeback and receive reimbursement for goods and services that they actually received. Data is available within the payment system to identify those credit cards that have a propensity for chargeback. Rules-based fraud engines do not track this negative data. Similarly, cyber extortion may be dealt with. Cyber extortion is different from cyber shoplifting in that the fraud is perpetrated prior to the initiation of a chargeback. In this case the consumer/fraudster utilizes the Card Brand, Issuing Bank, and Acquiring Bank's rules, regulations, penalties, and culture to coerce a merchant into providing a refund for goods and services received without returning said products. Many merchants are considered at high risk because of the type of product they provide or because of the number of chargeback requests they receive. Rather than have a chargeback initiated that could result in penalties or a loss of payment processing capability, the merchant will acquiesce and give a refund. Currently there is no data in the system or method by which an extorted merchant can report and record this negative data. A global compilation is made difficult by the competitive nature of various retailers and the competitive nature of the card issuing banks. Fraudsters are able to exploit the fact that Bank 1 does not share data with Bank 2; Retailer 1 does not share data with Retailer 2; and VISA, MasterCard and Amex (and others) do not share data with one another. Accordingly, an important feature of the present invention is the gathering of data across these traditional business barriers. Such compiled data may be referred to as a so-called Consortium Database.

Card Brands, Issuing Banks and Acquiring Banks may decide to cooperate according to the present invention instead of being divided and conquered.

The most logical solution to this problem according to the present invention is to create a Consortium Database which receives transactional data from all merchants and combines that data where it can be utilized to identify negative behavior from a given credit card, including the propensity for a chargeback and forms of cyber extortion. The admin portal provided to a given merchant would allow them to input against a given transaction number a flag when a cardholder attempted or accomplished an extorted refund. It was also clear that there was a need to track SKU level data in order to pinpoint those areas of the highest volume of sales and fraudulent activity including cyber shoplifting and cyber extortion. The admin portal may be accessed via enterprise servers or even via so-called apps for display on tablets or smartphones, which may be particularly useful for small business owners.

It is also evident that the consortium database can not only be used to store the negative data associated with fraudulent transactions, but it can also be used to track the individual characteristics and shopping behavior of a given card. The analytics engine associated with the consortium database could then be used by the merchant to suggest either a more suitable product based upon the cardholder's previous habits or associated products.

A complete system envisioned according to the present invention may include any of the following components:

Consortium Database (Both Negative and Positive Data)
transactional data from merchants
SKU level data from merchant transactions
refunds and returns data from merchant transactions
chargeback data from merchant transactions
cyber extortion data input from merchants
previous scores from fraud screening engines

Analytics Engine
utilizing any scoring engine
analyzes data to predict a potential fraudulent transaction (provides transaction scoring)
analyzes data to provide suggestions for better or associated products to the consumer
capable of analyzing data and providing a given output based upon industry standards, rules and regulations

Industry Tailored Output Engine
Consortium Database and Analytics Engine outputs can be tailored to meet the requirements of any given industry or merchant.
feeds re-presentment information to a chargeback management system according to the present invention. In one aspect of the present invention, a method for transaction processing may comprise; requesting stored data from an Application Programming Interface (API), validating a request from the API, logging the request, querying to a database to retrieve data relevant to the request, interpreting the request, and generating output to a reporting API.

In another aspect of the present invention, a method for transaction processing may comprise; entering a checkout, entering payment information from a consumer, collecting device information from a merchant, sending the payment information along with the device information to a fraud scoring system, calculating a fraud score in a fraud decision engine, presenting the merchant with an authentication method, and generating an order review page.

In yet another aspect of the present invention, a method for transaction processing may comprise; sending a CNP authorization and authentication to a decision engine, sending data from an API to a business logic layer, validating the data and sending the data to an appropriate gateway specific component, sending an authorization request to a gateway, sending authorization results to the appropriate gateway specific component, and parsing the authorization results.

In another variation of this invention, the software is configured for native or hybrid usage on a consumer “app” so that small business owners may directly interface the invention without the need for costly POS terminal devices. With such a variation, the present invention may be realized by components such as Mobile Apps, Support Servers, and Data Services.

Mobile Apps are the applications that run on various mobile devices, and communicate with the Support Servers to send and retrieve relevant data as described in this document. The Support Servers are the set of components designated as the server-side infrastructure supporting all Mobile App server data requests and responses; they communicate to the Mobile Apps to respond to requests for information and to act as a conduit to other services for the Mobile Apps. The Support Servers also communicate with the Data Services and are the sole communication channel to the Data Services for the purposes of the Mobile Apps. The Data Services collectively refer to the collection of heterogeneous components and services that support the Mobile Apps, and communicate exclusively with the Support Servers for the purpose of the Mobile Apps.

Each of these primary components may be broken down into further sub-components and their requirements according to the present invention. Enhanced POS systems that take advantage of the present invention gives users the ability to track sales and profitability, market to customers with automated email marketing and social media marketing tools, and sell anywhere.

With respect to tracking sales, online back office reports and dashboards enable users of the present invention to monitor operations remotely.

With respect to marketing, the present invention enables users of the present invention to monitor all critical data elements. In addition, automated email marketing and social media tools give users the ability to easily stay connected to customers. Customized messages to alert guests of specials, deals and announcements about retail operations may be facilitated.

A User Feature List may include:
1. Consolidated client data/database to inform fraud detection
2. Pre-Payment Fraud Detection in general
3. Pre-Payment judgment of card holder analytics in a self-calibrating neural network using a consortium database
4. Terms and Conditions Display/Access
5. Display of current Terms and Conditions to the user
6. Capture of User agreement to current T&C
7. Terms and Conditions easily changed & Signature Capture enabled as desired
8. Order capture/proof of order
9. Chargeback support
10. Payment Types Handled will include case, mobile pay, credit card, key-in, etc.
11. User Login
   11.A. Synchronization of products/orders
   11.B. User analytics
12. Re-order
   12A. Re-order previously purchased products/orders
   12.B. Order trend data
13. Tipping
14. Taxes calculation/display
   14A. Pre-configured, or
   14.B. Automatic location awareness
15. Printer Connections of many types will be supported
16. Receipts (paper, email, etc.)
17. Save purchase details
18. Refunds
19. Product Management
   19A. Import
      19A.1. Barcode scanner
      19A.2. External software
      19A.3. External servers
   19.B. Synchronized Products across all devices
   19.C. Inventory management (e.g. stock levels)
20. Cash Tracking
21. Multiple language support
22. Reports
   22.A. Sales
   22.B. Market trends
   22.C. Custom
23. Customer Service Integration
24. Secure communications between all components (PCI Compliant)

These and other aspects, objects, features and advantages of the present invention, are specifically set forth in, or will become apparent from, the following detailed description of an exemplary embodiment of the invention.

### BRIEF DESCRIPTION OF THE DRAWINGS

Various embodiments of the present disclosure, together with further objects and advantages, may best be understood by reference to the following description taken in conjunction with the accompanying drawings, in the several Figures of which like reference numerals identify like elements, and in which:

FIG. 1 is a schematic block diagram of a system for processing electronic transactions over a network;

FIG. 2 is a high-level order flow of exemplary process that may implement the present invention;

FIG. 3 is a flow diagram of high-level message flow for a ADS transaction;

FIG. 4 illustrates one possible embodiment of a scoring and passive authentication system (SPAS);

FIG. 5 depicts a more detailed block diagram of the automated retrieval and chargeback processing module or system shown in FIG. 1;

FIG. 6 is a block diagram which depicts one possible embodiment of an automated retrieval and chargeback operations;

FIG. 7 depicts a more detailed block diagram of the automated retrieval and chargeback processing module or system shown in FIG. 1;

FIG. 8 is an example embodiment of the integration touch points for an automated retrieval and chargeback response system;

FIG. 9 depicts a more detailed block diagram of the automated retrieval and chargeback processing module shown in FIG. 6;

FIG. 10 an example embodiment of an automated retrieval and chargeback system;

### DETAILED DESCRIPTION OF THE PREFERRED EMBODIMENT

One embodiment of the present invention provides a framework for recognizing, storing, and matching domain knowledge about retrieval and chargeback requests and the domain of the possible response actions. The input system interfaces with file transfer systems such as secure file transfer protocol as well their own independent and non-standard user interfaces, such as web pages, to process certain aspects of a chargeback. The output of said interface encompasses a variety of appropriate response actions including: file and data responses, messaging for additional or missing data, summaries of request and responses for later review, interfaces to printers and facsimile machines, and addition of items to workflow and queuing systems.

A preferred embodiment of an automated retrieval and chargeback response system according to the present invention is shown in the figures. Using this system, the data is normalized whereby the intent and scope of a retrieval and chargeback request is determined from the data within the request, and the system responds to that intent in a way that is appropriate to the card association's and/or payment schema's unique domain.

In a simple case, a consumer initiates a chargeback with their issuing bank, which in turn submits the chargeback to the appropriate card association or payment schema. The card association or payment schema shall then submit the chargeback request to the merchant's acquiring bank. The system receives the chargeback request from either a push or pull process flow from the card association, payment schema, or acquiring bank. The systems normalization and rules engine determines the appropriate action based upon the request data, the card association or payment schema, and the availability of merchant transaction data. If the system has the appropriate and required merchant data as determined by the normalization and rules engine, the system shall generate an automated response.

However, in cases where merchant transaction data is missing, the system might send a notification to the merchant requesting the missing details. The system would provide an input interface for a merchant to providing the missing data. Also, the system might send reminder notifications to the merchant when their input is required and has not been received.

The system's normalization and rules engines recognizes which card association or payment schema corresponds to the chargeback or retrieval request and maps these to domain knowledge pertaining to appropriate responses to decrease and/or prevent future chargeback requests as well as increase chargeback reversal rates. The response generated from the system can take a variety of forms, such as sending an electronic response to the requestor, sending an electronic response to a third party system, printing out the response to be carried by conventional postal delivery services, or outputting to facsimile services or machines.

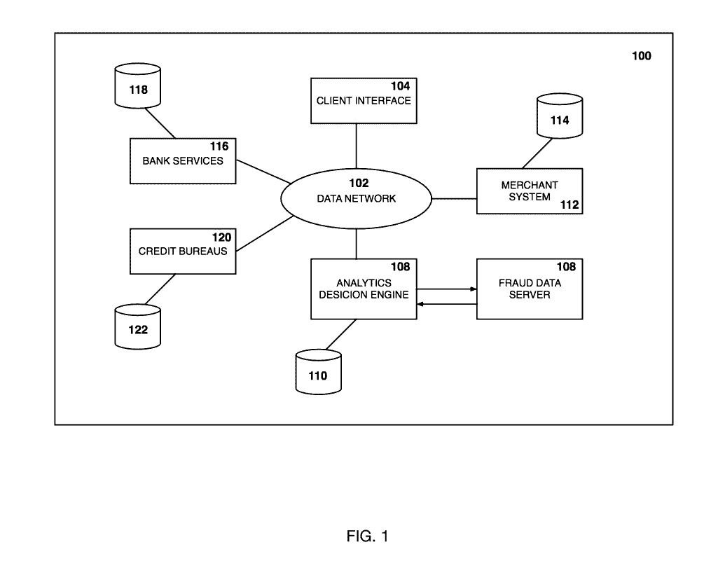

FIG. 1 is a schematic block diagram of a system for processing electronic transactions over a network. According to the preferred embodiment of the present invention, FIG. 1 is a high-level block diagram of an exemplary system 100 that may implement the present invention. A client interface 104 may communicate with a network 102, which may be any type of wired or wireless network. The invention may further comprise an analytics decision engine 106 in communication with the network 102 and a database 110. A fraud data server 108 may communicate with the analysis decision engine 106. A merchant system 112 useful for implementation in the system 100 may be in communication with the network 102 and a database 114. Bank services 116, such as card issuers, may be in communication with the network 102 and a database 118. Credit bureaus 120, connected to at least one database 122, may communicate with the network 102. It should be readily apparent that the present invention may be applied to existing online or other electronic commerce applications. One purpose of this system is to facilitate the purchase of goods and services. The feature leverages the data in the consortium database populated by the fraud scoring system 108 as well as other data sources such as, but not limited to, credit bureaus 120, social media, and FICO score. This process can be used during the checkout process to present the consumer with alternate and/or additional products. It can also be used post checkout or after cart abandonment using communication methods such as, but not limited to, email, SMS, MMS, and social media.

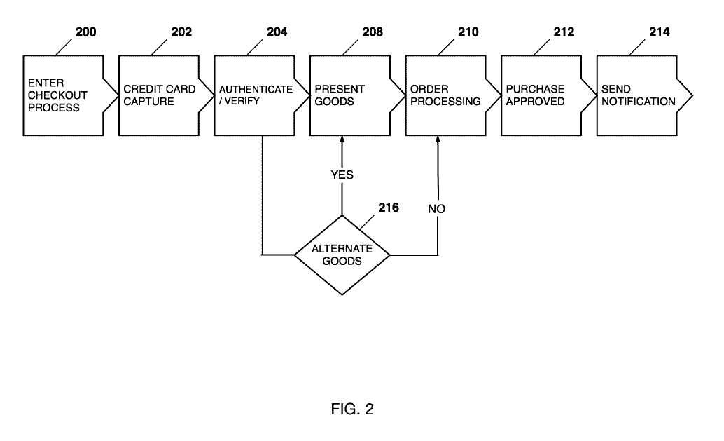

FIG. 2 is a high-level order flow of exemplary process that may implement the present invention. In accordance with the preferred embodiment of the present invention, the customer enters the checkout process 200 and payment information is then entered using credit card capture 202. The credit card information is authenticated and verified 204. The customer has the option of adding alternate goods 216 to the order, and the goods to be purchased are presented 208 to the customer. The order is processed 210 and the purchase is approved 212. A notification of completed purchase is then sent 214 to the customer.

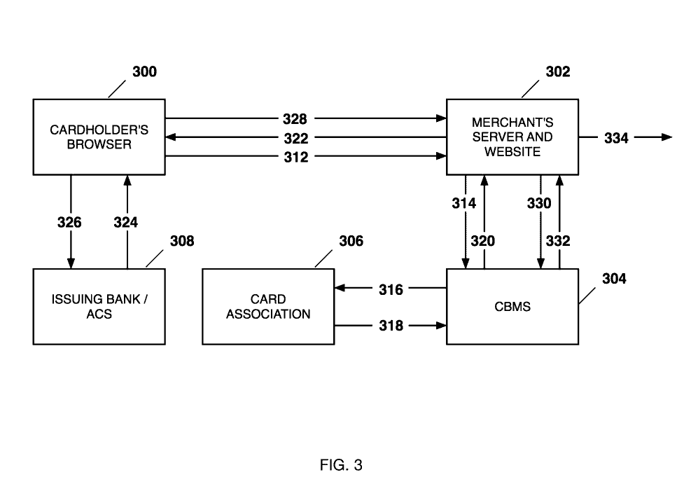

FIG. 3 is a flow diagram of high level message flow for an Authentication Data Service (ADS) transaction. In accordance with the preferred embodiment of the present invention, the cardholder enters their credit card number 300 and submits their transaction information 312 to the merchant 302. Upon receiving the transaction request, the merchant 302 calls 314 the Chargeback Management System (CBMS) ADS API 304 to verify card enrollment. The CBMS ADS API 304 receives the request, authenticates the merchant 316, and use the CBMS MPI to send a VERES (verify enrollment request) to the CA 306. The CA 306 verifies if the card is enrolled and returns the issuer URL 318. CBMS MPI 304 decrypts the response 320 from the CA 306 and sends the info the CBMS API 304; which in turn sends it to the merchant 302. The CBMS ADS thin client installed at the merchant 302 receives the response from the CBMS ADS API 322. If the card is enrolled the thin client opens an inline window in the Cardholder browser 300. If the card is not enrolled the transaction can be sent to the processor; however, the merchant in this case would be liable to a chargeback. Otherwise the merchant 302 can chose not to continue with the transaction. The cardholder browser 300 uses the URL returned from CA 306 via the merchant to communicate directly 324 to the issuing bank 308. The contents of the inline window are loaded and the cardholder enters their pin. The information is submitted 326 to the bank 308 and authenticated. A response is then returned to the cardholder's browser 300. The cardholder's browser 300 receives the response from the bank and forwards 328 it to the merchant 302. The merchant 302 receives the response info from the cardholder browser 300 and makes a call 330 to the CBMS ADS API 304. Step 11: CBMS ADS API 304 receives the request, ACS request and authenticates the information 332. The CBMS MPI 304 then provides a CAVV value to the merchant 302. If ADS was successful, status is “Y” then the merchant may proceed with the CAVV purchase or CAVV preauthorization. If ADS failed with status of “N”, the transaction must be cancelled as cardholder failed to authenticate. If ADS failed with a status of “U” or the response times out, the transaction can be processed as a normal purchase or preauthorization; however, in this case the merchant assumes liability to a chargeback. Step 12: The merchant 302 retrieves the CAVV value and formats a CAVY purchase or a CAVY preauthorization request using the method that is normally used 334. As part of this transaction method the merchant 302 must pass the CAVV value.

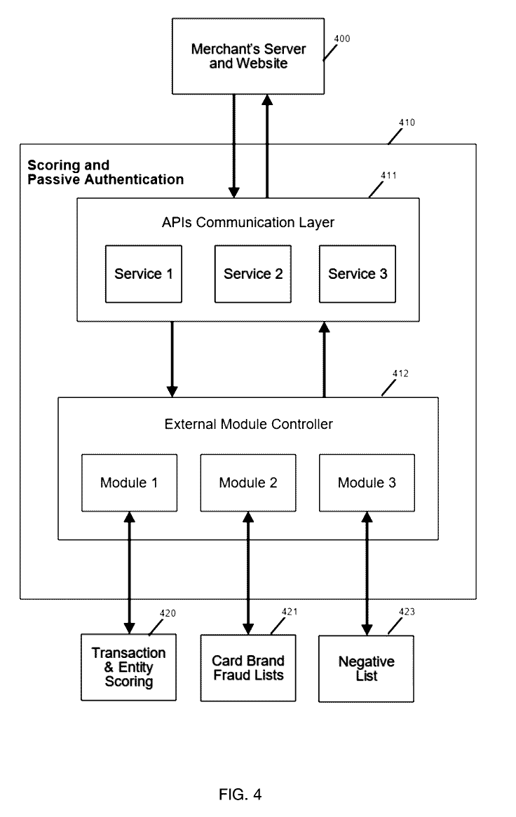

FIG. 4 illustrates one possible embodiment of a scoring and passive authentication system (SPAS). It is merely an example of a preferred embodiment.

A commerce system 400 during the checkout process sends transaction data, card data, customer data to SPAS 410. The SPAS API layer 411 receives the data package and then passes the scoring and passive authentication request to the external module controller 412. The external module controller 412 contains individual modules designed to communicate back and forth with external modules/systems. The external modules, such as transaction and entity score 420, are used to help determine a score for a transaction and execute a passive authentication attempt.

The module 1 within the external module controller 412 sends transactional, credit card, customer, and payment device data to the transaction and entity score 420, which in turn returns a score to the SPAS 410. Then module 2 in the external module controller 412 uses the credit card data to query the appropriate card brand fraud list 421. The card brand 421 will respond with a message denoting if the specified credit card is on their fraud list. Module 2 will consume and translate the message and the result is used by SPAS 410 to enhance its data models and algorithms. Module 3 in the external module controller 412 will make a request to the negative list system 423 using credit card data; which returns a Boolean (true or false). Once again, the SPAS 410 will use the result from the negative list to enhance its scoring and passive authentication data models and algorithms.

Once the external module controller 412 have has collected results from all of the external systems using its modules, the SPAS 410 will execute its data models and algorithms to generate a score and passive authentication result. The API layer 411 will send scoring and passive authentication response package back to the commerce system 400. If response score denotes a good possibility that the transaction is fraudulent and that passive authentication failed, then the commerce system 400 would interrupt or abort the checkout process. If the response score denotes a low possibility of fraud and/or passive authentication passed, then the commerce system 400 would allow the checkout to continue as normal.

Importantly, the data exchanged between the SPAS 410, via the individual modules within the external module controller 412, and the external systems 420, 421, 422 can be used by all systems to enhance their future analysis of commerce transactions.

Additionally, the negative lists system 423 could also return a score used to rank the level of abuse seen for the specific credit card. A credit card that only has one chargeback with a fraud reason code and the chargeback date was after a certain date, then it could be considered less negative as compared a card with multiple fraud chargebacks in the very recent past.

Additionally, the negative lists system 423 is not exclusive to credit cards having one or more chargebacks with a fraud reason code. The system 423 can also apply the similar logic to other actions such as return or previous reported fraud history to incorporate into its response and score(s).

Additionally, SPAS 410 could return just a score to the commerce system 400. The commerce system 400 could rely exclusively in the score from SPAS 410 or it could execute its own logic in addition to the score.

Finally, SPAS 410 is not limited to the external systems 420, 421, 422 outlined in the diagram. SPAS 410 can use information for other external systems to enhance its capabilities, such as biometric identification, knowledge-based authentication, phone number verification, and geolocation.

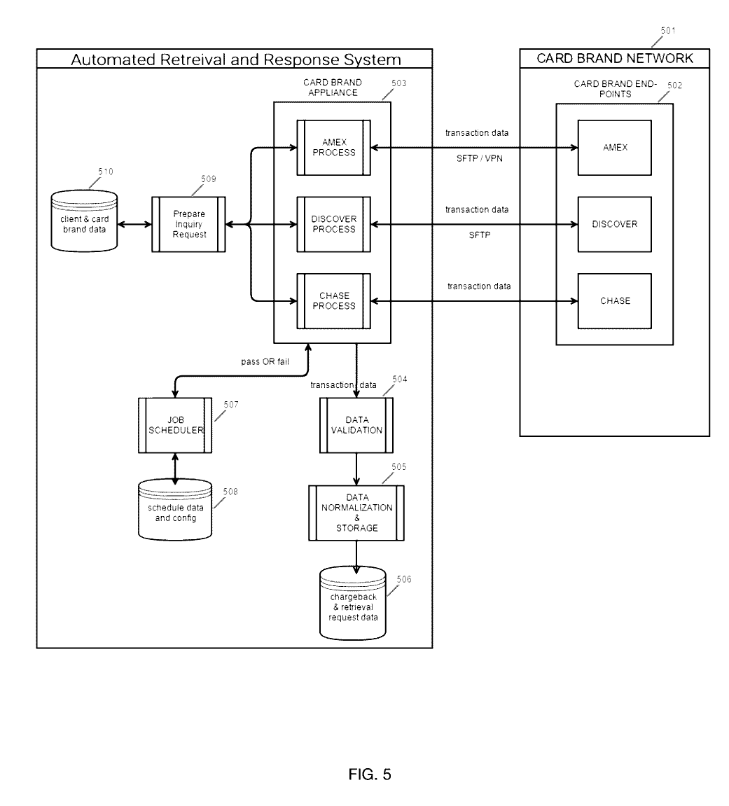

FIG. 5 depicts a more detailed block diagram of the automated retrieval and chargeback processing module or system shown in FIG. 1. It is merely an example of a preferred embodiment.

In the card brand networks 501 a chargeback request has been initiated or sent to the card brand itself. The card brand endpoints 502 will push the chargeback requests to automated retrieval and chargeback system (ARS). ARS has individual card brand appliances 503 for each card brand and entity with connectivity to ARS. ARS will perform data validation 504 and data normalization 505 into the universal format and saved the data in the appropriate data store 506. A recurring scheduled job 507 based upon configuration setting 508 will attempt to process pending requests, ARS will be able either process (pass) or not process (fail) each pending request automatically.

Those chargeback requests that can be processed during the job 507 will results in the ARS generating the appropriate response package 509, send the package, and store the package. The response package 509 can utilize data from one or more data sources, such as the client and card brand data 510.

The card brand appliances 503 will push the response packages back to the card brand endpoints 502 within the card brand networks 501.

Additionally, the card brand appliances 503 can pull the chargeback requests from the card brand endpoints 502. And the card brand endpoints 502 can pull the response packages from the card brand appliances 503. Either system can push or pull for the chargeback requests and response packages.

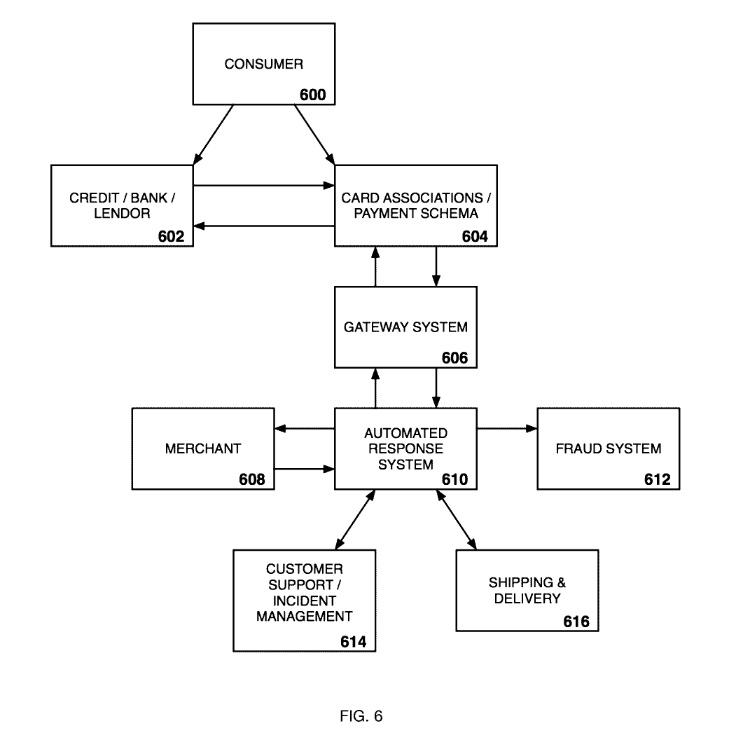

FIG. 6 illustrates one possible embodiment of an automated retrieval and chargeback operation. A consumer 600 notifies their issuing bank or credit card company 602 of a desire to remove a transaction from a credit card. The credit card company 602 sends a chargeback request to the card association or payment schema 604, which in turn sends the request to the automated retrieval and chargeback system 610. The automated retrieval and chargeback system 610 pulls the required merchant data from the merchant 608, compiles a response package and sends the response back to the card association or payment schema 604. The card association or payment schema 604 sends the response back to the credit card company 602 for assessment and disposition. Importantly, 610 provides for the normalization and data logic translation necessary to practice the present invention. In short, varying discrete data formats and protocols must be configured so that they are all compatible with each other and the overall data flow under control by the system according to the present invention. Then, rules engines in effect by the various card associations or payment schema can be accomplished by uniform data translation logic according to the present invention.

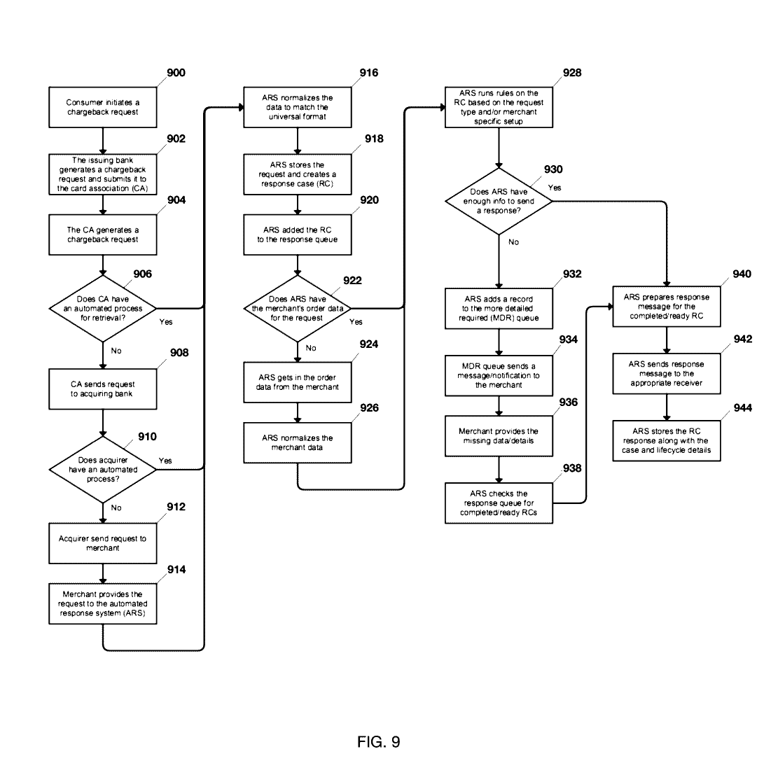

This is one possible data flow; however, not all card associations have automated process available to the general public. As such, the system has the ability to work with other entities, such as acquiring banks, in the chargeback flow further down the line (not shown; see FIG. 9). In this case the automated retrieval and chargeback system 610 would be responding to the same entity used to obtain the request.

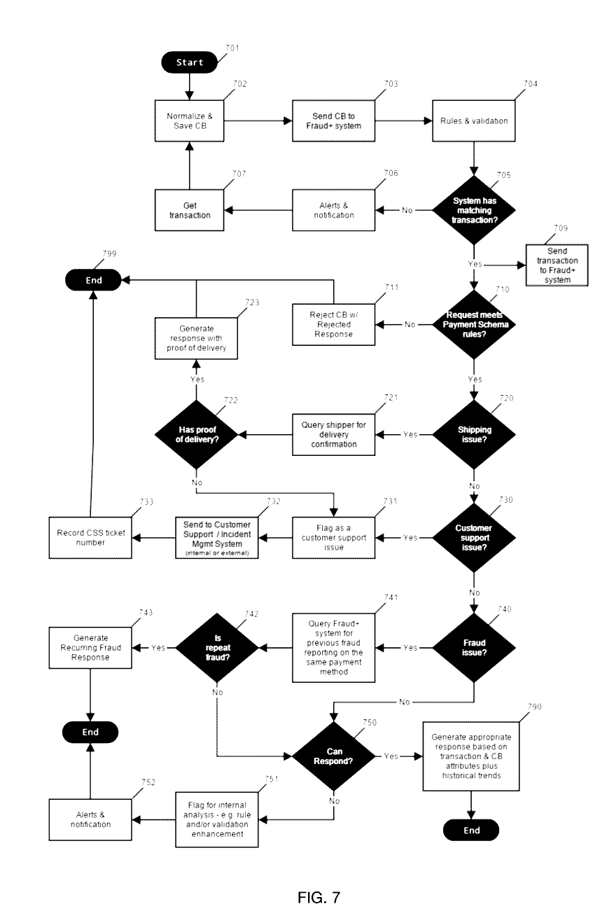

FIG. 7 depicts a more detailed block diagram of the automated retrieval and chargeback processing module or system shown in FIG. 1. It is merely an example of a preferred embodiment. In 701, a chargeback request has been initiated and the request will be automatically consumed by the system for data normalization into the universal format, saved, and will generate a response case 702. The system sends the chargeback request to the Fraud+ system 703 for future requests and a negative database. The system sends the request to rules engine for processing and validation 704. The system checks if it already has the merchant's order data and documentation 705 to complete an automated response. If not and the system cannot automatically collect the data from the merchant, a notification and/or alert 706 will be initialized and associated with the response case, and an interface 707 for a merchant to upload the missing transaction is available. If the matching transaction is found, the system sends the transaction 709 to the Fraud+ system as well as additionally validations and rules in the data logic translation and rules engine 704 to determine if it can or should respond to the request 790. One of the additional validations is to verify the chargeback request adheres to corresponding card brand and payment rules 710. If not, the system shall reject the request with an appropriate response package 711, send the package, and store the package.

If the request does meet the rules and regulations 710, then additional validations and rules can be executed. For example, if the chargeback reason code denotes that the consumer did not receive the shipment 720, then the system can make a call to the shipper 721 to request shipping status and proof of deliver. If the shipper confirms delivery 722, then the system shall generate the appropriate response package 723, send the package, and store the package. If the shipper cannot confirm delivery or confirms the shipment was not delivered 722, then the request can be flagged as a customer support issue, send a request to the merchant customer support/incident management system 732 in order to open a support ticket, record the support ticket number 733 against the request and/or response case, and a notification and/or alert 706 can be initialized and associated with the response case.

If the request is not a customer support issue 730, then additional validations and rules can be executed. For example, if the chargeback has a fraud reason code 740, then the system can query the Fraud+ system 741 to determine if the same credit card or payment device has been seen on previous chargeback requests with a fraud reason code. If the card or device was reported on a prior request with a fraud reason code 742, then the system shall generate the appropriate response package 743, send the package, and store the package. If not, then the system could run more validations and rules to determine if it needs additional data or if it can respond to the request.

If it can respond 750, the system shall generate the appropriate response package 790, send the package, and store the package. If it cannot respond 750, the system shall flag it for immediate intervention and/or for future analysis and enhancement 751, and a notification and/or alert 752 can be initialized and associated with the response case.

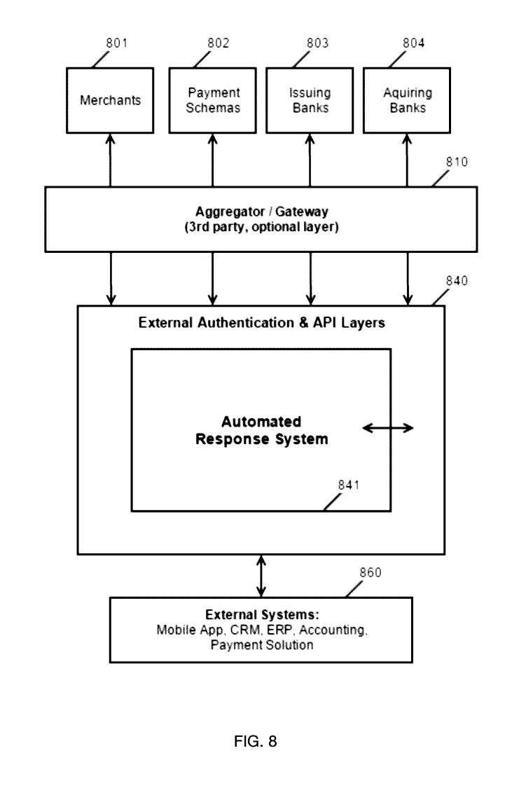

FIG. 8 is an example embodiment of the integration touch points for an automated retrieval and chargeback response system 841 implemented as a service 840 over the Internet. The system's application programming interfaces (APIs) 840 can be accessed by different domains and entities in the payment ecosystem. Merchants 801, card brands and payment schemas 802, issuing banks 803, and acquiring banks and processors 804 can use an aggregator/gateway 810 to connect indirectly or bypass and go direct to the APIs 840. There are advantages to using an aggregator/gateway 810; for example, the gateway system 810 could provide some level of data normalization and validation prior to the data flowing into the automated retrieval and chargeback response system 841 through the service layer 840.

Additionally, other systems such as a mobile app 860, CRM and ERP systems 860, accounting software and systems 860, and payment systems 860 can connect the automated retrieval and chargeback response system 841 through the service layer 840. Additionally, these systems 860 can connect to an aggregator/gateway 810. One of the benefits to allowing other systems 860 connectivity directly or indirectly is that single integration can allow multiple merchants access the automated retrieval and chargeback response system 841 with zero or very limited integration needed to be completed by a merchant itself, thus eliminating or reducing the initial cost of consuming a new service.

FIG. 9 depicts a more detailed block diagram of the automated retrieval and chargeback processing module or system shown in FIG. 6. It is merely an example of a preferred embodiment.

In 900, a consumer initiates a chargeback request with the issuing bank of the credit card. The issuing bank generates and submits a chargeback request 902 to the CA who in turn sends 908 the CB request to the acquiring and/or sponsoring bank of the merchant. If the system has connectivity with the CA or the CA has an automated retrieval process for merchants 906, then the request will be automatically consumed by the system for data normalization 916. If the system cannot receive the request from the CA 906, but it does have connectivity with the acquiring and/or sponsoring bank 910, then the request will be automatically consumed by the system for data normalization 916. If the system cannot receive the request from the CA 906 or automatically from the acquiring and/or sponsoring bank 910 then the acquiring and/or sponsoring bank will send the request to merchant 912. In 914 the system will consume the request thru the merchant in an automated or manual process.

Once the system has the chargeback request, the request and its data will be normalized 916 into the universal format, saved, and will generate a response case 918. The response case is added to a queue 920 for processing. The system checks if it already has the merchant's order data and documentation 922 to complete an automated response. If not, the system will attempt to automatically collect the data from the merchant 924 which is then normalized 926, stored, and associated with the response case. The system runs the response case thru the data logic translation and rules engine 928 to determine if it can or should respond to the request 930. If the system should respond but cannot, it will add a record to a queue to request more information from the merchant 932, send a message/notification to the merchant 934, and the merchant can provide the missing details 936. The system will prepare the proper response package 940, send the package 942, and store the package 944.

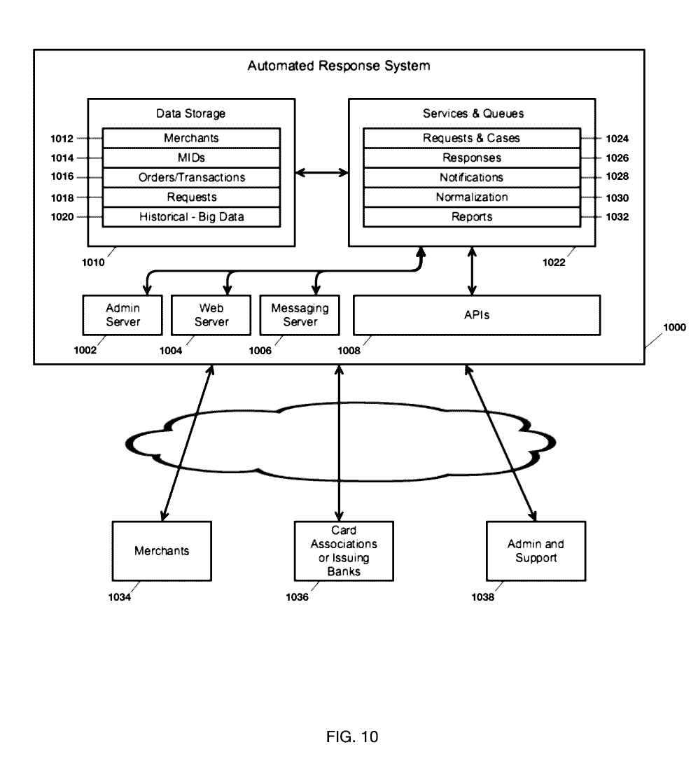

FIG. 10 is an example embodiment of an automated retrieval and chargeback response system 1000 implemented as a service over the Internet. The system is comprised of services and queues 1022, data storage 1010, application programming interfaces (APIs) 1008, messaging server 1006, web server 1004, and an admin server 1002. Services and queues 1022 are shown comprising of requests and cases 1024, responses 1026, notifications 1028, data normalization 1030, reports 1032, and a rules engine or data translation logic (not shown). Data storage 1010 is shown comprising of storage of merchants and their specific data 1012, merchant identification numbers (MIDs) 1014, merchant orders and transaction data 1016, retrieval and chargeback requests 1018, and historical data in the form of big data for the purposes of reporting and continuous updating and evaluation of the rules based on the final disposition to maximize the number of successful dispositions.

The system interacts directly with merchants and their systems 1034, card association or issuing banks and their systems 1036, an administration and support personnel and their systems 1038.

While various embodiments of the disclosed technology have been described above, it should be understood that they have been presented by way of example only, and not of limitation. Likewise, the various diagrams may depict an example architectural or other configuration for the disclosed technology, which is done to aid in understanding the features and functionality that may be included in the disclosed technology. The disclosed technology is not restricted to the illustrated example architectures or configurations, but the desired features may be implemented using a variety of alternative architectures and configurations. Indeed, it will be apparent to one of skill in the art how alternative functional, logical or physical partitioning and configurations may be implemented to implement the desired features of the technology disclosed herein. Also, a multitude of different constituent module names other than those depicted herein may be applied to the various partitions. Additionally, with regard to flow diagrams, operational descriptions and method claims, the order in which the steps are presented herein shall not mandate that various embodiments be implemented to perform the recited functionality in the same order unless the context dictates otherwise.

Although the disclosed technology is described above in terms of various exemplary embodiments and implementations, it should be understood that the various features, aspects and functionality described in one or more of the individual embodiments are not limited in their applicability to the particular embodiment with which they are described, but instead may be applied, alone or in various combinations, to one or more of the other embodiments of the disclosed technology, whether or not such embodiments are described and whether or not such features are presented as being a part of a described embodiment. Thus, the breadth and scope of the technology disclosed herein should not be limited by any of the above-described exemplary embodiments.

Terms and phrases used in this document, and variations thereof, unless otherwise expressly stated, should be construed as open ended as opposed to limiting. As examples of the foregoing: the term “including” should be read as meaning “including, without limitation” or the like; the term “example” is used to provide exemplary instances of the item in discussion, not an exhaustive or limiting list thereof; the terms “a” or “an” should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

While various embodiments of the disclosed technology have been described above, it should be understood that they have been presented by way of example only, and not of limitation. Likewise, the various diagrams may depict an example architectural or other configuration for the disclosed technology, which is done to aid in understanding the features and functionality that may be included in the disclosed technology. The disclosed technology is not restricted to the illustrated example architectures or configurations, but the desired features may be implemented using a variety of alternative architectures and configurations. Indeed, it will be apparent to one of skill in the art how alternative functional, logical or physical partitioning and configurations may be implemented to implement the desired features of the technology disclosed herein. Also, a multitude of different constituent module names other than those depicted herein may be applied to the various partitions. Additionally, with regard to flow diagrams, operational descriptions and method claims, the order in which the steps are presented herein shall not mandate that various embodiments be implemented to perform the recited functionality in the same order unless the context dictates otherwise.

Although the disclosed technology is described above in terms of various exemplary embodiments and implementations, it should be understood that the various features, aspects and functionality described in one or more of the individual embodiments are not limited in their applicability to the particular embodiment with which they are described, but instead may be applied, alone or in various combinations, to one or more of the other embodiments of the disclosed technology, whether or not such embodiments are described and whether or not such features are presented as being a part of a described embodiment. Thus, the breadth and scope of the technology disclosed herein should not be limited by any of the above-described exemplary embodiments.

Terms and phrases used in this document, and variations thereof, unless otherwise expressly stated, should be construed as open ended as opposed to limiting. As examples of the foregoing: the term “including” should be read as meaning “including, without limitation” or the like; the term “example” is used to provide exemplary instances of the item in discussion, not an exhaustive or limiting list thereof; the terms “a” or “an” should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

The presence of broadening words and phrases such as “one or more,” “at least,” “but not limited to” or other like phrases in some instances shall not be read to mean that the narrower case is intended or required in instances where such broadening phrases may be absent. The use of the term “module” does not imply that the components or functionality described or claimed as part of the module are all configured in a common package. Indeed, any or all of the various components of a module, whether control logic or other components, may be combined in a single package or separately maintained and can further be distributed in multiple groupings or packages or across multiple locations.

Additionally, the various embodiments set forth herein are described in terms of exemplary block diagrams, flow charts and other illustrations. As will become apparent to one of ordinary skill in the art after reading this document, the illustrated embodiments and their various alternatives may be implemented without confinement to the illustrated examples. For example, block diagrams and their accompanying description should not be construed as mandating a particular architecture or configuration.

Embodiments presented are particular ways to realize the invention and are not inclusive of all ways possible. Therefore, there may exist embodiments that do not deviate from the spirit and scope of this disclosure as set forth by appended claims, but do not appear here as specific examples. It will be appreciated that a great plurality of alternative versions are possible.

2. An apparatus according to claim 1 for processing a payment transaction and for automatically processing a chargeback request, comprising:
a. storing in an account database a plurality of account profiles, wherein each account profile includes data related to a payment account including at least an account identifier;
b. further storing data indicative of a consumer request to reverse a consumer charge activity related to said account database;
c. a processor whereby said consumer request is recorded in a master consumer chargeback database, wherein said consumer requests are originated from a plurality of card brands and a plurality of merchants, so that said master consumer chargeback database contains data not obtainable from a single card brand;
d. an automatic chargeback disposition process whereby each card brand may establish a series of rules sufficient to either issue a credit to said consumer in response to said consumer request or deny said request; and
e. a data gathering program for assessing the frequency and magnitude of each of said automatic chargeback dispositions and creating a disposition report indicative of the amount of chargeback avoided by way of said automatic chargeback disposition process.

3. An apparatus according to claim 2 wherein a smartphone is used to monitor said disposition report and inform business management as to chargeback avoidance.

4. An apparatus according to claim 1 wherein a smartphone is used by credit card consumers to store said credit card information to form a payment wallet, and wherein said payment wallet contains data indicative of consumer information that may be integrated into said chargeback disposition process.

5. An apparatus according to claim 1 wherein said automated chargeback disposition process is enabled alongside a traditional manual chargeback disposition process and wherein said manual chargeback disposition process is used to verify accuracy of a subset of said automated chargeback dispositions to assess automated chargeback disposition system effectiveness.

6. A method for processing a payment transaction and for automatically processing a chargeback request, comprising:
a. storing a plurality of account profiles, wherein each account profile includes data related to a payment account including at least an account identifier;
b. further storing a consumer request to reverse a consumer charge activity related to said account database;
c. processing said consumer request wherein said consumer requests are originated from a plurality of card brands and a plurality of merchants, so that said master consumer chargeback database contains data not obtainable from a single card brand;
d. automatically disposing of chargeback requests whereby each card brand may establish a series of rules sufficient to either issue a credit to said consumer in response to said consumer request or deny said request.

7. A method according to claim 6 for processing a payment transaction and for automatically processing a chargeback request, comprising:
a. storing a plurality of account profiles, wherein each account profile includes data related to a payment account including at least an account identifier;
b. further storing a consumer request to reverse a consumer charge activity related to said account database;
c. processing said consumer request wherein said consumer requests are originated from a plurality of card brands and a plurality of merchants, so that said master consumer chargeback database contains data not obtainable from a single card brand;
d. automatically disposing of chargeback requests whereby each card brand may establish a series of rules sufficient to either issue a credit to said consumer in response to said consumer request or deny said request and
e. gathering data representing the frequency and magnitude of each of said automatic chargeback dispositions and creating a disposition report indicative of the amount of chargeback avoided by way of said automatic chargeback disposition process.

8. A method according to claim 7 wherein a smartphone is used to monitor said disposition report and inform business management as to chargeback avoidance.

9. A method according to claim 8 wherein said smartphone is used by credit card consumers to store said credit card information to form a payment wallet, and wherein said payment wallet contains data indicative of consumer information that may be integrated into said chargeback disposition process.

10. A method according to claim 7 wherein said automated chargeback disposition process is enabled alongside a traditional manual chargeback disposition process and wherein said manual chargeback disposition process is used to verify accuracy of a subset of said automated chargeback dispositions to assess automated chargeback disposition system effectiveness.
